(19) United States
(12) Patent Application Publication
(10) Pub. No.: US 2022/0097508 A1
(43) Pub. Date: Mar. 31, 2022

(54) Protective Cover System for a Recreational Vehicle Roof

(71) Applicant: Lisa Gervasi, Cornville, AZ (US)

(72) Inventor: Lisa Gervasi, Cornville, AZ (US)

(21) Appl. No.: 17/067,240

(22) Filed: Oct. 9, 2020

Related U.S. Application Data
(60) Provisional application No. 63/084,286, filed on Sep. 28, 2020.

(51) Int. Cl. B60J 11/04

(52) U.S. Cl. CPC B60J 11/04

(57) ABSTRACT

This present invention relates to a protective cover system for a recreational vehicle (RV) roof. The protective cover system is removably and repositionably attached to the RV roof, and protects the same from ultraviolet rays, the weather, insect and pest infestations, and more. The protective cover system is made up of a plurality of sections or cells installed on the RV roof and covered by one or more protective covers, wherein at least some of the cells are repositionable under the cover relative to other of the cells to accommodate other structures that may be present on the roof of the RV.

### CROSS-REFERENCE TO RELATED APPLICATION

The present application claims priority to, and the benefit of, U.S. Provisional Application No. 63/084,286, which was filed on Sep. 28, 2020 and is incorporated herein by reference in its entirety.

### BACKGROUND OF THE INVENTION

The present invention relates generally to the field of covers or removable tops for recreational vehicles. More specifically, the present invention relates to a roof cover or protective top for a recreational vehicle which is intended to help protect the recreational vehicle from inclement weather, environmental exposure, leakage, and the like. The recreational vehicle (RV) roof cover has a frame with multiple sections enclosed with mesh screen, Plexiglas, glass, tin, aluminum, fiberglass, plastic or other material with vents to help maintain and preserve the roof, pipes, sunroof, air conditioning unit, or the like that are often found on the roof of an RV. More specifically, the present invention utilizes an awning or tarp material that buttons or snaps into support braces, thereby maintaining the cover and preventing it from lifting off or relocating during inclement weather. Accordingly, the present specification makes specific reference thereto. However, it is to be appreciated that aspects of the present invention are also equally amenable with other like applications, devices and methods of manufacture.

By way of background, recreational vehicles are a type of vehicle that includes indoor living quarters designed to allow people to enjoy camping and other outdoor activities with at least basic amenities. Recreational vehicles have become more popular as families and retirees look to travel to places via the open road, while enjoying the comforts of home. RVs are present in various forms including, without limitation, motor homes, campervans, caravans (also known as travel trailers and camper trailers), fifth-wheel trailers, popup campers, truck campers and the like.

Typically, recreational vehicles have a flat roof for improved aerodynamics when travelling. Unfortunately, flat roofs are exposed to sunlight, rain, snow, sleet, hail, wind and/or harsh weather conditions, and tend to accumulate debris, snow, rain water and the like. Further, most flat roofs do not drain properly (e.g., because they have little or no pitch), which can cause damage to the roof, and internal damage to the recreational vehicle as well. Oftentimes, the recreational vehicle roof can be one of the entrance points for leakage, insects, or the like. For example, leakage due to rain water or exposure due to snow or inclement weather conditions may damage the wiring or electrical systems of the RV, or cause damage to the interior of the RV. Further, leakage of the roof or leakage around other components on top of the RV including, without limitation, an air conditioner, antenna, or other structure, may cause mold to develop which may, in turn, lead to health issues. Additionally, insects and other pests can easily make their way into the pipes, build nests, chew through insulation and wires and cause significant damage to the recreational vehicle. Therefore, there exists a need for a solution to prevent the recreational vehicle from leakage issues due to inclement weather conditions, and from pest infestation.

Historically, to protect the recreational vehicle from harsh weather conditions, a user may park or store the recreational vehicle in a garage, shed, or other covered structure. While this may protect the RV when not in use, it does nothing to protect the recreational vehicle while travelling to various places and/or when the same is in use and uncovered. More specifically, when in use or travelling, as opposed to being stored in a garage or other covered structure, the recreational vehicle is naturally exposed to extreme weather conditions such as rain, snow, heat, wind or the like, and can easily become damaged for the reasons previously stated.

Other solutions exist in the state of the art to protect recreational vehicles from being exposed to harsh and extreme weather conditions. As an example, sheets or covering manufactured using plastic or other water proof material are available in the market, and can be used to cover the roof of the recreational vehicle while using the RV, or the to cover the complete vehicle when the RV is not in use. Unfortunately, such coverings or sheets require a lot of effort of the user to set up the covering over the recreational vehicle and its roof, and it is oftentimes difficult to keep the same in the proper position during events of inclement weather, such as high winds, storms and the like. More specifically, such coverings tend to become easily removed or tampered with after being exposed to harsh conditions. For example, the covering or sheet may be blown away or splayed out of position when the recreational vehicle is exposed to high winds or wind gusts.

Additionally, the existing roof covering products are fixed in size and are not adjustable. Therefore, a person is required to buy different sized sheets to cover recreational vehicles of different sizes. Also, if the roof is covered with said sheet and the user needs to access the roof, the user has to remove the covering or sheet to access the roof and then replace the protective covering after the work has been completed, which is both labor intensive and time consuming. Accordingly, an adjustable sized cover for the roof of recreational vehicles is required.

Furthermore, most existing covers for recreational vehicles are typically flat. Although the roof cover prevents the internal portion of the recreational vehicle and the roof from exposure to snow, wind, rain and the like when actually covered, the flat cover does not facilitate the snow, rain or other debris rolling off of the cover or the roof. Much manual effort is the required to remove the accumulated snow, rain or other debris from the roof. This causes inconvenience to the user, and may result in damage to the recreational vehicle itself if left unattended to.

Therefore, there exists a long felt need in the art for a cover for use on the roof of recreational vehicles that protects the recreational vehicle from inclement weather, leakage and exposure to the elements. There is also a long felt need in the art for a roof cover for a recreational vehicle that prevents the RV roof, pipes, sunroof, air conditioning unit, and others elements exposed on the roof from becoming damaged, and that prevents insects and other pests from infiltrating the RV or any of its components. Moreover, there is also a long felt need in the art for a roof cover that is capable of eliminating any snow, rainwater or other debris that may accumulate on the roof cover over time, and that is adjustable in size and height for the convenience of the user. Finally, there is a long felt need in the art for a roof cover that can be easily attached to a recreational vehicle, is repositionable and relatively inexpensive to manufacture, and that is both safe and easy to use.

The subject matter disclosed and claimed herein, in one embodiment thereof, comprises a roof cover for use with a recreational vehicle. The roof cover is comprised of a frame preferably manufactured from a metal, such as iron, steel, aluminum or the like, wherein the various frame elements are enclosed with a mesh screen, Plexiglas, glass, tin, aluminum, fiberglass, plastic or any other suitable material having one or more vents to help protect the RV's roof, pipes, sunroof, air conditioning unit, or the like. More specifically, the frame is comprised of multiple box sections snapped onto the vehicle via bar supports. The roof cover includes an aerodynamic wind barrier, and utilizes an awning or tarp material that buttons, snaps or is otherwise secured to a plurality of support braces. In a further embodiment, the frame is also comprised of adjustable legs that would allow the roof cover to be customized to those RVs having somewhat pitched roofs and/or a curved frame structure that reduces the likelihood of substantial snow and other debris accumulating on the roof cover.

In this manner, the recreational vehicle roof cover of the present invention accomplishes all of the forgoing objectives, and provides a relatively robust and convenient covering for the vehicle roof which can be installed according to the preferences of the user. The roof cover helps protect the roof of the recreational vehicle from inclement weather, leakage, wind, rain, snow, and the like, and also helps to prevent the infestation and/or nesting of insects and other pests on the roof of the recreational vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

In one embodiment, the subject matter disclosed and claimed herein comprises a novel roof cover for use with a recreational vehicle. The roof cover is comprised of a metal frame that is enclosed with a mesh screen, Plexiglas, glass, tin, aluminum, fiberglass, plastic or other suitable material having vents, and protects the RV roof, and any components positioned thereon, from sunlight, the elements, debris and/or infestation. More specifically, the frame includes multiple box-like sections that are snapped onto the vehicle and held in position by bar supports. The roof cover includes an aerodynamic wind barrier and utilizes an awning or tarp material that buttons or snaps onto support braces. Further, the frame includes adjustable legs that would allow the roof cover to accommodate differently pitched RV roofs.

In an alternative embodiment, the subject matter disclosed and claimed herein includes an improved recreational vehicle roof cover. The recreational vehicle roof cover is comprised of: (a) a frame having multiple sections, wherein each of said multiple sections is comprised of two opposite side legs connected through elongated members; (b) a front sloping section; (c) a first layer enclosing the frame, wherein the first layer is made up of mesh screen, Plexiglas, glass, tin, aluminum, fiberglass, plastic or similar material; and (d) a second layer over the first layer, wherein the second layer is comprised of a tarp or awning type material.

In a further embodiment of the present invention, the first layer enclosing the frame completely covers the frame and is comprised of one or more vents to provide for ventilation and/or the exchange of air, such as the air released from air conditioning units, internal vents or the like. The side legs and elongated members of the frame are adjustable in size to accommodate the various elements that may be positioned on a roof of a recreational vehicle, or different roof pitches. More specifically, the side legs can be adjusted to position the roof cover to different heights relative to the roof surface and as per the requirements of the user. Accordingly, the size of the multiple sections of the frame can be set in order to accommodate the variation in height or elevation of the different elements on top of the RV. The recreational vehicle roof cover of the present invention is further comprised of an aerodynamic wind barrier mounted over the roof cover. Further, the frame of the roof cover may be removably or repositionably attached to the RV using a series of clamps or other fastening mechanisms, such as Velcro, threaded fasteners and the like.

In a further embodiment of the present invention, the awning or heavy-duty rain resistant material which is provided for the second layer is one piece, and is snapped on or otherwise secured to the legs of the frame using buttons, snaps, threaded elements or other suitable fastening mechanisms. In a further embodiment, the improved roof cover utilizes a generally V-shaped bracket or arm attached to the RV roof to secure the front awning thereto, and to ensure that the roof covering system remains in place while travelling or during prolonged periods of storage.

In yet another embodiment of the present invention, a curved roof cover for a recreational vehicle is disclosed. The recreational vehicle roof cover comprising a frame having two or more sections; with each section having two opposite side legs connected through curved elongated members; a front sloping section; a first layer enclosing the frame, and the first layer is made up of one or more of a mesh screen, Plexiglas, glass, tin, aluminum, fiberglass, plastic or the like; and a second layer positioned over the first layer, wherein the second layer is made up of a tarp or awning material.

In a further embodiment of the present invention, the curved shape of the roof cover provides a slightly rounded or curved structure frame to allow rain and snow to easily run off the sides of the recreational vehicle, and not accumulate thereon. The first layer over the frame may include one or more vents for ventilation, and the side legs and the elongated members supporting the frame are adjustable in size to accommodate the roof and any elements that may be positioned thereon. More specifically, the side legs can be adjusted in length to position the roof cover at different heights relative to the specific topography of the roof arrangement. Further, the recreational vehicle roof cover of the present invention may also comprise an aerodynamic wind barrier, and the frame of the roof cover may be attached to the RV by clamps or other suitable fastening mechanisms.

In a still further embodiment of the present invention, a topographic adjustable covering for a recreational vehicle roof is presented, and includes an adjustable frame having a perimeter and a series of rails and legs with at least one of the rails and legs being longitudinally adjustable to accommodate different elements on a roof. A first layer is secured to the frame and a second layer is disposed over at least part of the first layer to protect the roof from the elements, pests, sunlight, and other environmental conditions.

In yet a further embodiment of the present invention, a combination roof covering system is disclosed. The combination roof covering system is for use on an RV roof, wherein the RV roof is comprised of flat areas and raised areas created by different functional components positioned on the roof. The combination roof covering system comprises a frame having a series of tubular legs, wherein each of the legs is extensible in a vertical or longitudinal direction, and a plurality of cells created by the frame and legs, with each of the cells covering a portion of the roof of the recreation vehicle. At least one of the plurality of cells has a height that is greater than the other cells of the plurality of cells.

In yet a still further embodiment of the present invention, a roof protection unit is disclosed and comprises a frame having a plurality of legs with each leg having first and second ends. A plurality of cells is formed by a pair of legs that are spaced apart from one another and form an individual cell. Each of the individual cells has a first and second layer of material to form a covering for the cell. At least one of the plurality of cells has a curved shape and at least one of the plurality of cells is disposed at a height greater than any other of the plurality of cells.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the RV roof cover of the present invention in accordance with the disclosed specification;

FIG. 2 illustrates a partial perspective view of one potential embodiment of the RV roof cover of the present invention in accordance with the disclosed specification;

FIG. 3 illustrates a perspective view of one potential embodiment of the RV roof cover of the present invention in accordance with the disclosed specification and attached to the roof of a recreational vehicle;

FIG. 4 illustrates a partial perspective view of one potential embodiment of the RV roof cover of the present invention in accordance with the disclosed specification, wherein a portion of the cover is curved;

FIG. 5 illustrates a perspective view of one potential embodiment of the legs of the RV roof cover of the present invention in accordance with the disclosed specification, wherein the legs are adjusted to different elevations to, for example, accommodate the topography of the roof of the recreational vehicle;

FIG. 6 illustrates a partial perspective view of one potential embodiment of the support system of the RV roof cover of the present invention in accordance with the disclosed specification; and

FIG. 7 illustrates a perspective view of one potential embodiment of the RV roof cover of the present invention in accordance with the disclosed specification and attached to the roof of a recreational vehicle and encompassing an AC unit.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there is a long felt need in the art for an RV roof cover that protects the recreational vehicle from inclement weather, leakage and exposure to the elements. There is also a long felt need for an RV roof cover that prevents the RV roof, pipes, sunroof, air conditioning unit, and others components exposed on the roof from becoming damaged, and that prevents insects and other pests from infiltrating the RV, or any of its components. Moreover, there is also a long felt need in the art for a roof cover whose shape resists the substantial accumulation of snow or other debris, and that is adjustable in size and height for the convenience of the user. Finally, there is a long felt need in the art for a roof cover that can be repositionably attached to a recreational vehicle to provide a user with access to the roof if needed, is relatively inexpensive to manufacture, and that is safe and easy to use.

The innovative product of the present invention features a roof cover for use with a recreational vehicle. In a preferred embodiment, the roof cover comprises a frame manufactured of a metal, such as iron, steel, aluminum or the like, which is enclosed with at least one of a mesh screen, Plexiglass, glass, tin, aluminum, fiberglass, plastic or other suitable material having at least one vent therein. The frame itself is comprised of a plurality of connected box or cell sections attached to the recreational vehicle via bar supports. The roof cover may further comprise an aerodynamic wind barrier, and utilizes an awning or tarp material that buttons or snaps onto a plurality of support braces. Further, the frame includes adjustable legs that allow the height of the roof cover relative to the roof of the recreational vehicle to be adjusted to accommodate different pitched roofs and/or other elements positioned on top of the roof of the RV, such as an AC unit, ladder, etc.

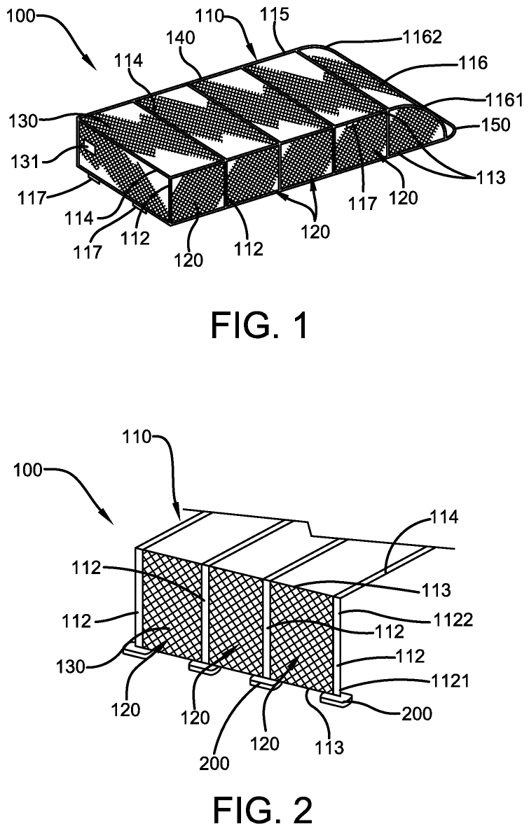

Referring initially to the drawings, FIG. 1 illustrates a perspective view of one potential embodiment of the RV roof cover/protection system 100 of the present invention in accordance with the disclosed specification. More specifically, the multifunctional RV roof protection system 100 comprises a frame 110 having a plurality of sections 120 in a manner similar to a luggage rack installed on the roof of a motor vehicle. The frame 110 is snapped onto the vehicle via a fastening mechanism such as bar supports or other fastening mechanisms, as will be described in connection with FIGS. 6 and 7 below. Each section or cell 120 of the frame 110 comprises two side legs 112 positioned on an edge 113, and two side legs 112 on an opposite edge 115, which are interconnected by one or more elongated members 114 extending therebetween connected at the edges 113 and 115, as best shown in FIG. 1. Each side leg 112 is preferably a tubular structure of a predetermined length that comprises a part of the frame 110, and permits the height of the roof cover 100 to be adjusted as per the topography of the roof of the RV. Alternatively, each side leg 112 may have a telescopic leg structure comprised of a lower end or portion 1121 and an upper end or portion 1122, thereby allowing the side legs 112 to be extensible in the vertical or longitudinal direction such that the user may adjust the height or length of each side leg 112 by extending or retracting the side leg portions 1121, 1122.

As previously stated, the frame 110 and its various components may be manufactured of a metal, such as an iron, stainless steel, aluminum, or the like, or any other suitable material, such as a plastic or wood, provided that the same are weather resistant. If the frame 110 is comprised of a metal, it may also be powder coated or painted with a rust resistant substance. Further, the edge members 113, 115, as well as the elongated members 114, may also be adjustable in length in a similar manner (e.g., telescoping) to accommodate different sized roofs or components on the roof of various recreational vehicles. Nonetheless, the shape of the side legs 112, edge members 113, 115, and elongated member 114 is not limited to a tubular shaped member, and may also be a flat structure or have another geometric cross-section, such as a square, rectangle, or the like.

In one embodiment, the frame 110 may further comprise a front section 116 having a sloping section. The slope-based structure of the front section 116 is formed by utilizing a first curved member 1161 and a second curved member 1162 attached to the edge member 113 and the opposite edge member 115 on the upper section of the frame 110, respectively. The curved members 1161 and 1162 provide an aesthetically appealing design to the RV roof protection system 100, and are provided to help improve the aerodynamics of the roof protection system 100 and prevent the same from blowing off of the RV when in motion. The curved members 1161 and 1162 are preferably of tubular construction, and have a predetermined length. However, the size and shape of the curved members 1161, 1162 are not so limited, and each of curved members 1161, 1162 may be of other suitable sizes and/or shapes as well.

Each section or cell 120 of the frame 110 of the RV roof cover 100 may be enclosed with a first layer covering 130, as best shown in FIG. 1. First layer covering 130 is preferably comprised of a mesh screen, Plexiglas, glass, tin, fiberglass, plastic or any other suitable material. The first layer covering 130 preferably has one or more vents 131, which provide ventilation and protect the RV roof, pipes, sunroof, air conditioning unit and the like from accumulating mildew by allowing proper air circulation. The first layer covering 130 provides a robust enclosure to protect the roof of the recreational vehicle from inclement weather conditions or the like, and acts as a first barrier to prevent pests, bugs, rodents and the like from nesting in the roof of the recreational vehicle.

The first layer enclosure 130 may be further covered with a second layer covering 140, wherein the second layer 140 is snapped or otherwise secured onto the first layer 130 or the frame 110 to enclose different sections or cells 120 of the frame 110. For example, the second layer 140 may be attached to ends of the side legs 112 of the frame 110 using buttons, snaps, hook and loop fasteners, or any other fastening mechanism known in the art. The second layer 140 is preferably comprised of an awning or a tarp material, or other suitable material, such as a waterproof canvas, vinyl, vinyl coated fabric, polyvinyl chloride, or the like. Similar to the first layer covering 130, the second layer covering 140 preferably also has one or more vents 131, which provide ventilation and protect the RV roof, pipes, sunroof, air conditioning unit and the like from accumulating mildew by allowing proper air circulation.

Notwithstanding the forgoing, it will be appreciated that the first layer covering 130 can be eliminated altogether, and the frame 110 or individual cells 120 may simply be covered, in whole or in part, by the second layer 140. Alternatively, select portions of the frame 110 (e.g., the sides) may be covered with a mesh-like first layer 130, and other portions of the frame (e.g., the top section) may be covered with a tarp-like second layer 140 to, for example, prevent rain or snow from entering the frame 110 and falling onto the roof of the RV.

Additionally, the frame 110 of the roof cover 100 may comprise one or more strategically placed hinges 117 to allow for the roof cover 100 to be repositioned relative to the roof of the RV to, for example, access the roof of the RV to make repairs thereto, without having to completely remove the roof cover 100. Further, various components of the frame 110 may also be hingedly attached to one another via hinges 117. For example, side legs 112, edges 113, 115, elongated members 114, curved members 1161, 1162 may be hingedly attached to rails 111 (see FIG. 6) to enable the user to lift up select portions of the roof cover 100 without disturbing other sections thereof

FIG. 2 illustrates a partial perspective view of one potential embodiment of the RV roof cover 100 of the present invention in accordance with the disclosed specification. More specifically, frame 110 of the RV roof cover 100 comprises a plurality of expansible sections or cells 120 that may be interconnected or connected with one another via fasteners (not shown) to enable a user to customize the shape and size of the roof cover 100 to suit a particular application, or a particular size or shape of a RV roof. Further, each side leg 112 of the frame 110 comprises a clamp or a support brace 200 attached to a lower end 1121 of the side leg 112 that enables the user to attach the roof cover 100 onto a roof of a recreational vehicle or rail system mounted on to the roof.

Upon assembly, the frame 100 may then be covered with either or both of first and second covering layers 130, 140, or a combination thereof as stated supra. The first and/or second covering layers 130 may be attached to each other, the frame 110 or any portion thereof, or to the support brace 200 using any of a snap, button, Velcro, buckle lock, or other suitable fastening means known in the art in order to prevent the first and/or second layer coverings 130, 140 from lifting or relocating during inclement or harsh weather conditions, travelling, etc.

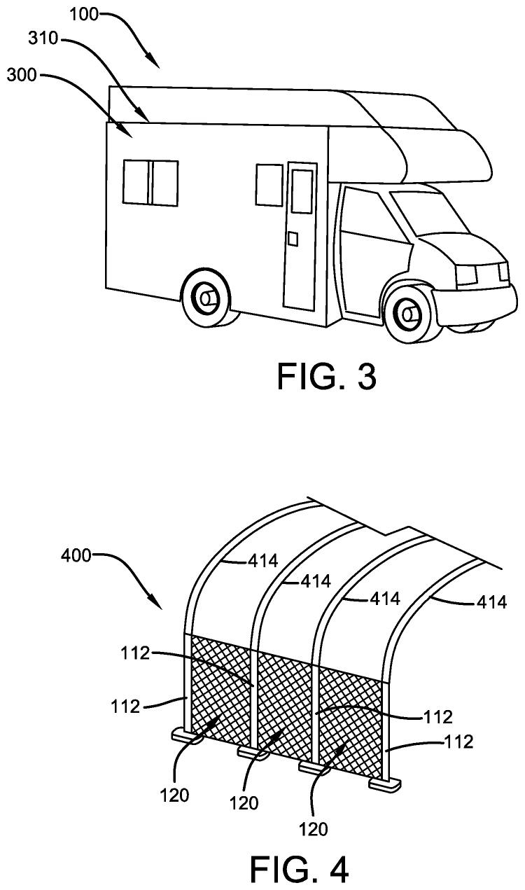

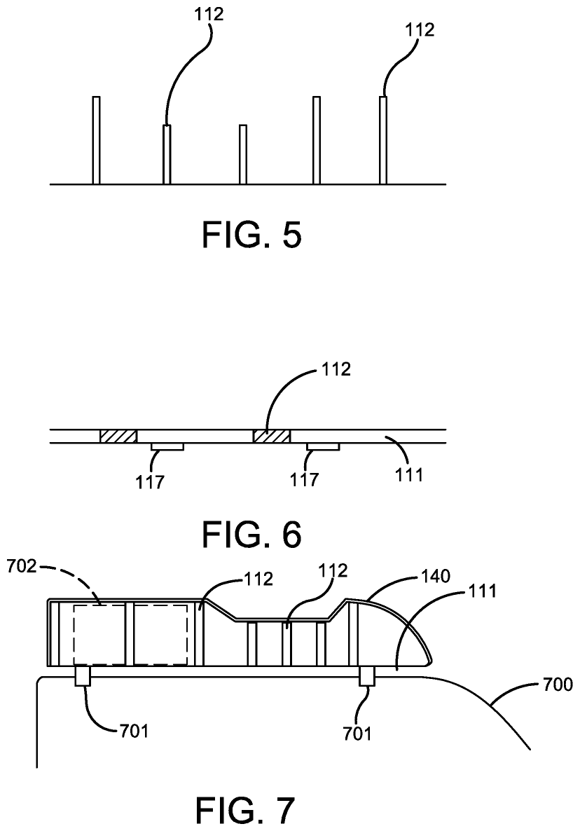

FIG. 3 illustrates a perspective view of one potential embodiment of the RV roof cover 100 of the present invention in accordance with the disclosed specification and attached to the roof 310 of a recreational vehicle 300. More specifically, the RV roof cover 100 of the present invention is preferably removably and repositionably (e.g., via hinges 117) attached to the roof 310 of the recreational vehicle 300 in any of the manners described herein. Also, as previously stated, the user can connect various cells or sections 120 together to accommodate the particular shape or size of the roof 310 of the recreational vehicle 300, even if the same is contoured or encumbered by other objects, such as an AC unit, ladder, vent, etc., as explained more fully below with respect to the discussion of FIGS. 5 and 7. Additionally, because the side legs 112 and other components of frame 110 are adjustable in length, the height of the roof cover 100, or select portions thereof, in relation to the roof 310 of the RV 300 can also be adjusted to suit user need and/or preference.

FIG. 4 illustrates a partial perspective view of one potential embodiment of the RV roof cover 400 of the present invention in accordance with the disclosed specification, wherein a portion of the roof cover 400 is curved. The structure of the curved RV roof cover 400 and the RV roof cover 100 described elsewhere herein are substantially similar, with the only distinction being the curved shape of certain elongated members. More specifically, the curved RV roof cover 400 comprises a plurality of curved elongated members 414 connecting side legs 112 on opposing sides of the recreational vehicle roof cover 400. The curved elongated members 414 may be tubular or flat shaped structures, and provide structural support for the first and/or second covering layers 130, 140 in the manner elsewhere described herein. The curved elongated members 414 are of a predetermined length forming a curvature over a top section of the frame 110 so as to allow rain, snow and other debris to easily slide off and over the sides of the curved RV roof cover 400. Alternatively, the size and height of the curved RV roof cover 400 may also be adjustable as elsewhere described herein (e.g., via telescoping members) as needed. The curved RV roof cover 400 protects the roof 310 of the recreational vehicle 300 from leakage, the accumulation of snow, water, and debris, and the nesting or infestation of insects, bugs and the like. The curved RV roof cover 400 also reduces direct sun contact on the roof 310, and ultimately extends the lifespan of the recreational vehicle 300.

Additionally, many recreational vehicles 300 have a ladder and/or a slide topper. In one embodiment of the present invention, the system allows a person to stand on the RV roof 310 by climbing up the ladder (not shown) to unsecure a slide topper. More specifically, the above brace bar of the frame of the cover system 100 of the present invention may be lifted up such that the top curved portion of both the frame and second layer 140 (if present) are removed. This can be done through the use of hinges 117, and tilting the roof cover 100 off to one side or lifting up the cover front to back, or vice versa. In another embodiment of the present invention, a dome of heavy duty or crack resistant plastic (not shown) may be attached to the frame 110 via hinges 117 (and in lieu of, or in addition to, covers 130, 140) and arms, so that the same can be repositioned to provide a user with access to the roof of the RV. The arms may be secured to the roof 310, or to the frame of the RV 300.

The awning material used for the second layer 140 increases the versatility, effectiveness and usefulness of the frame 110 and cover 100. More specifically, the awning material reduces the temperature of the frame 110 and the roof 310 of the RV 300 by shading the same from the sun and by allowing for air circulation via one or more vents 131 as described above. In one embodiment, the awning material may be a vinyl awning which is waterproof, scratch- and fade-resistant, and that also provides protection from the harmful effects of ultraviolet rays. In another embodiment, the second layer 140 may be a polyvinyl chloride, vinyl coated fabric or other similar material, and may be manufactured in different colors and sizes and has non-corrosive and reinforced corners on the edges, thus, ensuring a secure tie down or attachment with the support bars. The awning material resists mildew, acid and mold buildup by letting a small amount of air pass through, thereby keeping the RV roof 310 relatively clean and dry.

As described above, the awning material layer 140 can be manually secured to the support bar/brace. Alternatively, the second material layer 140 can be controlled and operated electrically, wherein a switch, button or an instruction through an associated Smartphone app (via a wireless communication technology such as Wi-Fi, Bluetooth, NFC or the like) causes the layer 140 (or the entire frame 110 itself) to reposition itself like a convertible cover for an automobile using commercially available components.

As previously stated, the cover system 100 may further comprise a wind barrier 150. The wind barrier 150 is designed to permit smooth airflow over the top of RV 300 and cover 100, 400. More specifically, the wind barrier 150 may be integrally formed with, or attached to, the frame 110 and/or roof 310 of the RV 300. By directing the airflow over the RV 300 and the protective cover 100/400, the wind barrier 150 helps reduce fuel consumption, thereby reducing overall fuel costs. When not integrally formed with the protective cover 100, the wind barrier 150 can be fitted to the roof bars and/or frame 110 using a fastening mechanism, such as clamps, bolts, fasteners, etc. The wind barrier 150 is relatively lightweight, and can work on recreational vehicles 300 of any size. Further, the wind barrier 150 may be comprised of an acrylonitrile butadiene styrene, and may range in forward facing (i.e., towards the front of the RV) height from between 20-40 cm.

The protective cover system 100 of the present invention substantially covers the roof 310 of the RV 300, and prevents leaks, inclement weather damage, infestation, etc. The protective cover system 100 further reduces direct sun contact on the roof 310, thereby extending the lifespan of the roof 310 of the RV 300. The protective cover system 100 is relatively easy to install and reposition as needed, is cost effective, and can be used on RVs of any type including, without limitation, 5th wheels, travel trailers, and Class A, B, and C motor homes and the like.

FIG. 5 illustrates a perspective view of one potential embodiment of the side legs 112 of the RV roof cover 100 of the present invention in accordance with the disclosed specification, wherein the legs 112 are adjustable to different lengths to, for example, accommodate the topography of the roof 310 of the recreational vehicle 300. More specifically, the side legs may be comprised of telescoping lower and upper portions 1121, 1122 as previously described.

FIG. 6 illustrates a partial perspective view of one potential embodiment of the support system of the RV roof cover of the present invention in accordance with the disclosed specification. The side legs 112 are attached to rails 111 of the frame 110 of the roof protection system 100. More specifically, the rails 111 may have slots therein to accommodate each of the side legs 112, and the side legs 112 may be positioned in any area of the slot, or be movable in the rails 111 to adjust for different components that may be on the roof of the recreational vehicle.

FIG. 7 illustrates a perspective view of one potential embodiment of the RV roof cover 100 of the present invention in accordance with the disclosed specification and attached to the roof of a recreational vehicle 700 and encompassing an AC unit 702. More specifically, FIG. 7 illustrates the RV 700 with the rail 111 and side legs 112 connected to the RV 700 via fasteners 701, which may be screws, adhesive, or other mechanical fasteners and the like. FIG. 7 also illustrates how the side legs 112 can be adjusted to different heights so as to accommodates different RV components on the roof of the RV, such as an air conditioner (shown in phantom) 702.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “recreational vehicle roof cover”, “RV roof protective system”, “RV roof cover”, “RV roof” and “roof cover” are interchangeable and refer to the RV roof cover 100 of the present invention. Also, the term “recreational vehicle” and “RV” are interchangeable and refer to a motor vehicle that includes living quarters designed for accommodation, and is used by people to travel to various places.

Notwithstanding the forgoing, the RV roof cover 100 of the present invention can be of any suitable size and configuration as is known in the art without affecting the overall concept of the invention, provided that it accomplishes the above stated objectives. One of ordinary skill in the art will appreciate that the size, configuration and material of the RV roof cover 100 as shown in the FIGS. are for illustrative purposes only, and that many other sizes of the RV roof cover 100 are well within the scope of the present disclosure. Although the dimensions of the RV roof cover 100 are important design parameters for user convenience, the RV roof cover 100 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A covering for a recreational vehicle roof comprising:
a frame comprised of a rail, at least one side leg, an edge, an opposite edge, and at least one elongated member, wherein the at least one side leg is telescoping;
a hinge attached to the frame; and
a first cover positioned over at least a portion of the frame.

2. The covering for a recreational vehicle roof as recited in claim 1, wherein the frame is comprised of a plurality of expansible sections.

3. The covering for a recreational vehicle roof as recited in claim 1, wherein the frame is further comprised of a plurality of curved members.

4. The covering for a recreational vehicle roof as recited in claim 1 further comprising a second cover.

5. The covering for a recreational vehicle roof as recited in claim 1, wherein the first cover comprises at least one vent.

6. The covering for a recreational vehicle roof as recited in claim 1, wherein the at least one side is inserted into the rail of the frame, and the frame is fastened to the recreational vehicle roof.

7. The covering for a recreational vehicle roof as recited in claim 1, wherein the frame is hingedly connected to the recreational vehicle roof via the hinge.

8. The covering for a recreational vehicle roof as recited in claim 1, wherein the first cover is comprised of at least one of a mesh screen, a Plexiglas, a glass, a tin, a fiberglass, or a plastic.

9. The covering for a recreational vehicle roof as recited in claim 1, wherein the first cover is comprised of at least one of a waterproof canvas, a vinyl, a vinyl coated fabric, or a polyvinyl chloride.

10. A combination roof and roof covering system comprising:
a roof provided on a recreational vehicle, wherein the roof is comprised of a flat area and a raised area;
a frame comprising a plurality of legs, wherein at least some of the plurality of legs are extensible in a longitudinal direction; and
a plurality of cells comprised of the plurality of legs, an edge, an opposite edge, and a plurality of elongated members, wherein each of the plurality of cells covers a different portion of the roof of the recreational, and further wherein at least one of the plurality of cells has a height greater than other cells in the plurality of cells.

11. The combination roof and roof covering system as recited in claim 10 further comprising a hinge for repositioning the frame relative to the roof.

12. The combination roof and roof covering system as recited in claim 10, wherein the plurality of legs are attached to a series of rails that are attached to the roof.

13. The combination roof and roof covering system as recited in claim 10 further comprising a first cover that covers at least a portion of the frame.

14. The combination roof and roof covering system as recited in claim 13, wherein the first cover is selected from a group including a mesh, a screen, a Plexiglas, glass, a tin, an aluminum, a fiberglass, a plastic or a combination thereof.

15. The combination roof and roof covering system as recited in claim 13, wherein at least a portion of the first cover is covered by a second cover.

16. The combination roof and roof covering system as recited in claim 15, wherein the second cover is comprised of at least one of a waterproof canvas, a vinyl, a vinyl coated fabric, or a polyvinyl chloride.

17. The combination roof and roof covering system as recited in claim 10 further comprising a first cover that covers at least a portion of the frame and a second cover that covers a different portion of the frame than the first cover.

18. A recreational vehicle roof protection system comprising:
a frame comprised of a plurality of cells, wherein each of the plurality of cells is comprised of a plurality of side legs, an edge, an opposite edge, and an elongated member;
a hinge attached to the frame;
a wind barrier; and
a first cover covering at least a portion of the frame and a second cover covering a different portion of the frame than the first cover, wherein at least one of the plurality of cells has a curved shape, and further wherein at least one of the plurality of cells is disposed at a height greater than at least one other of the plurality of cells.

19. The recreational vehicle roof protection system as recited in claim 18, wherein the first cover is different than the second cover.

20. The recreational vehicle roof protection system as recited in claim 18, wherein each of the side legs is extendable in a longitudinal direction.
